(19) United States
(12) Patent Application Publication
(10) Pub. No.: US 2026/0235281 A1
(43) Pub. Date: Aug. 13, 2026

(54) A LED FILAMENT LAMP

(71) Applicant: SIGNIFY HOLDING B.V., EINDHOVEN (NL)

(72) Inventors: TIES VAN BOMMEL, HORST (NL); ROBERT JACOB PET, WAALRE (NL)

(21) Appl. No.: 19/155,995

(22) PCT Filed: Jan. 31, 2024
(86) PCT No.: PCT/EP2024/052328

§ 371 Date: Aug. 13, 2025

(30) Foreign Application Priority Data
Feb. 14, 2023 (EP) 23156455.0

(51) Int. Cl. F21V 23/04; F21K 9/232; F21K 9/238; F21V 23/00; F21V 23/06; F21Y 103/10; F21Y 115/10; H05B 47/19

(52) U.S. Cl. CPC F21V 23/0435; F21K 9/232; F21K 9/238; F21V 23/002; F21V 23/06; H05B 47/19; F21Y 2103/10; F21Y 2115/10

(57) ABSTRACT

A LED filament lamp (1) adapted for, in operation, emitting LED filament lamp light, the LED filament lamp (1) comprising at least two rigid electrically conducting wires (2, 3), one or more LED filaments (41-43), a controller (6), a radio (25) and at least one antenna (5), where the one or more LED filaments (41-43) are mechanically and electrically connected to the at least two rigid electrically conducting wires (2, 3) and the rigid electrically conducting wires (2, 3) are electrically connected to the controller (6), where the at least one antenna (5) is mechanically connected to but electrically isolated from the at least two rigid electrically conducting wires (2, 3), where the controller (6) is functionally coupled to the radio (25), where the at least one antenna (5) is electrically coupled to the controller (6), and where the antenna (5) is spaced apart from each of the one or more LED filaments (41-43) by a distance D.

### FIELD OF THE INVENTION

The invention relates to a LED filament lamp adapted for, in operation, emitting LED filament lamp light, and comprising at least two rigid electrically conducting wires, one or more LED filaments, at least one antenna, an envelope at least partly enclosing the one or more LED filaments, and a cap for electrically and mechanically connecting the LED filament lamp to a lamp socket.

### BACKGROUND OF THE INVENTION

A trend in lighting is LED filament lamps. An LED filament lamp is an LED lamp which comprises a LED filament, and which is designed to resemble a traditional incandescent light bulb with a visible filament for aesthetic and light distribution purposes, but with the high efficiency of light-emitting diodes.

A LED filament is providing LED filament light and comprises a plurality of light emitting diodes (LEDs) arranged in a linear array. Preferably, the LED filament has a length L and a width W, wherein L>5 W. The LED filament may be arranged in a straight configuration or in a non-straight configuration such as for example a curved configuration, a 2D/3D spiral or a helix. Preferably, the LEDs are arranged on an elongated carrier like for instance a carrier, that may be rigid (made from, e.g., a polymer, glass, quartz, metal or sapphire) or flexible (e.g., made of a polymer or metal, e.g., a film or foil).

In case the carrier comprises a first major surface and an opposite second major surface, the LEDs are arranged on at least one of these surfaces. The carrier may be reflective or light transmissive, such as translucent and preferably transparent.

As used herein, the terms carrier and elongated carrier may be used interchangeably, such that the elongated carrier may also simply be denoted carrier.

The LED filament may comprise an encapsulant at least partly covering at least part of the plurality of LEDs. The encapsulant may also at least partly cover at least one of the first major surface and second major surface. The encapsulant may be a polymer material which may be flexible such as for example a silicone. Further, the LEDs may be arranged for emitting LED light, e.g., of different colors or spectrums. The encapsulant may comprise a luminescent material that is configured to at least partly convert LED light into converted light. The luminescent material may be a phosphor such as an inorganic phosphor and/or quantum dots or rods. The phosphor may comprise a first phosphor providing green/yellow light and/or a second phosphor providing red light. The first phosphor may comprise YAG and/or LuAG. The second phosphor may comprise a KSiF phosphor.

The LED filament may comprise multiple sub-filaments.

Another trend in lighting is connected lighting or connected lamps. Connected lamps are lamps provided with an antenna enabling the lamps to connect to one another, optionally via a controller or driver, and thus to be controlled in dependence of one another. US 2019/0191535 A1 discloses a lighting device with a LED filament. The LED filament comprises a substrate having an elongated body with an extension along an elongation axis, a plurality of LEDs mechanically coupled to the substrate, and a communication element or antenna mechanically coupled to the LED filament. The communication element is configured for wireless communication. The communication element may further be communicatively coupled to a controller, the controller being configured to receive a control signal from the communication element for controlling operation of the plurality of LEDs of the LED filament. The communication element is arranged on the substrate of the filament. The communication element may also be at least partially integrated in or with, or wound around, an encapsulation of the filament.

It is desired to provide a LED filament lamp which has an antenna that has a well-defined position in the LED filament lamp, is mechanically well supported in the LED filament lamp, interferes to a minimum with the electrical connection of the LEDs and/or that does not, or only to a relatively small extent, interfere with the light output of the LED filament lamp.

US2019086037 discloses a LED filament light bulb that includes a plurality of LED filaments, an RF driver, an antenna, and a cover. The antenna defines a first end portion and a second end portion, where the first end portion of the antenna is electrically connected and in signal communication with the RF driver. The cover defines an external wall and a support structure. The external wall defines an interior volume and the support structure defines an evacuation passageway and a cavity. The evacuation passageway and the antenna are both received within the cavity of the support structure and the evacuation passageway is fluidly connected to the interior volume of the cover.

CN108870112 provides a full-angle bendable LED filament strip which comprises a plurality of LED filament strip units connected sequentially in an end-to-end mode. Every two adjacent LED filament strip units are mutually and rotatably connected through a rotating part. A plurality of LED chips located on all the LED filament strip units achieve circuit communication through the rotating parts.

WO22148648 A1 discloses a light generating device comprising a number of filaments (200), a power distribution unit, and electronics (500); wherein the power distribution unit comprises electrically conductive tracks separated by electrically insulating material, and at least two of the electrical contacts of the filaments are functionally coupled to at least two different electrically conductive tracks. The at least two different electrically conductive tracks are functionally coupled to the electronics, that comprise one or more of a control system, a driver, and a transformer.

### SUMMARY OF THE INVENTION

It is an object of the present invention to overcome this problem, and to provide a LED filament lamp which has an antenna that has a well-defined position in the LED filament lamp, is mechanically well supported in the LED filament lamp, interferes to a minimum with the electrical connection of the LEDs and/or that does not, or only to a relatively small extent, interfere with the light output of the LED filament lamp.

According to a first aspect of the invention, this and other objects are achieved by means of a LED filament lamp adapted for, in operation, emitting LED filament lamp light, the LED filament lamp comprising at least two rigid electrically conducting wires, one or more LED filaments, a controller, a radio and an antenna, where the one or more of LED filaments are mechanically and electrically connected to the at least two rigid electrically conducting wires, and the at least two rigid electrically conducting wires are electronically connected to the controller, where the antenna is electrically isolated from the at least two rigid electrically conducting wires or the antenna is electrically connected to only one of the at least two rigid electrically conducting wires, where the controller is functionally coupled to the radio, where the antenna is electrically coupled to the radio, and where the antenna is spaced apart from each of the one or more LED filaments by a distance D.

Thereby, and particularly by providing that the at least one antenna is connected to but electrically isolated from the at least two rigid electrically conducting wires, and that the at least one antenna is electrically coupled to a controller, a LED filament lamp is provided which has an antenna that has a well-defined position in the LED filament lamp, that is mechanically well supported in the LED filament lamp, and that interferes to a minimum with the electrical connection of the LEDs. The antenna can be mechanically connected to both rigid electrically conducting wires by a mechanical yet electrically isolating connector, or only to one of both rigid electrically conducting wires by a mechanical yet electrically isolating connector and to the other one of both rigid electrically conducting wires in a mechanical and electrically connecting manner, for example, by a solder drop. Alternatively the antenna can be mechanically and/or electrically connected to only one of the two rigid electrically conducting wires.

In an embodiment, the radio is any one of a radio communication unit, a radio unit, a radio frequency unit, and a RF unit. The radio may further comprise one or more of a modulator, a digital/audio converter (DAC) and an amplifier.

In an embodiment, the controller is electrically coupled to the radio.

In an embodiment, at the location where the one or more LED filaments and the antenna are mechanically connected to the two rigid electrically conducting wires, the at least two rigid electrically conducting wires extend alongside each other, and preferably extend mutually in parallel.

Thereby, the antenna is mechanically particularly well supported in the LED filament lamp.

In an embodiment, the one or more LED filaments extend mutually in parallel, the parallel arrangement can, for example, be in line or next to each other.

Thereby, a LED filament lamp with a particularly simple electrical connection is achieved. The orientation of the one or more LED filaments in a parallel configuration provides for a good optical configuration, e.g., to provide 360 degrees illumination. It is also a nice design seen from an aesthetic point of view.

In an embodiment, the one or more of LED filaments are arranged in a column configuration.

Thereby, a LED filament lamp in which the LED filament structure formed by the one or more LED filaments, and in particular the plurality of LED filaments, may have a wider variety of shapes, such as for instance a shape resembling a spiraling filament. The orientation of the one or more LED filaments in a column configuration is furthermore a good optical configuration, e.g., to provide 360 degrees illumination. It is also a nice design seen from an aesthetic point of view.

In an embodiment, the antenna and the one or more LED filaments are arranged in parallel, the parallel arrangement can, for example, be in line or next to each other.

The orientation of the one or more LED filament to the antenna is also important to reduce or prevent interference and to improve the sending and/or receiving performance of the antenna. A parallel configuration is in this context a good configuration. Furthermore, a LED filament lamp is thereby provided in which the antenna only to a relatively small extent interferes with the light output of the LED filament lamp is obtained.

In an embodiment, the antenna and the one or more LED filaments are arranged in the column configuration.

The orientation of the one or more LED filament to the antenna is also important to reduce or prevent interference and to improve the sending and/or receiving performance of the antenna. A column configuration is in this context a good configuration. Furthermore, a LED filament lamp is thereby provided in which the antenna only to a relatively small extent interferes with the light output of the LED filament lamp is obtained.

In an embodiment, the antenna is provided with a cover covering the antenna at least partly, and the cover comprises one or more of the same color, the same shape, the same length, the same width, the same thickness and the same orientation with respect to the longitudinal axis of the LED filament lamp, as at least one of the one or more LED filaments.

For instance, the cover and the one or more LED filaments may have a yellow or an orange color. For instance, the cover and the one or more LED filaments may both have a filament shape. For instance, the cover and the one or more LED filaments may both have a length of between 3 and 10 cm. For instance, the cover and the one or more LED filaments may both have a width of between 3 and 8 mm. For instance, the cover and the one or more LED filaments may both have a thickness of between 3 and 8 mm. For instance, the cover and the one or more LED filaments may both be centrally arranged with respect to the longitudinal axis of the LED filament lamp.

Thereby, a LED filament lamp in which the antenna to a minimized extend or not at all interferes with the light output of the LED filament lamp is obtained. Such an antenna is furthermore to a large extend masked from being visible, or at least not readily discernible from the one or more LED filaments, in the off-state of the LED filament lamp. This in turn also provides for a LED filament lamp being rendered more aesthetic from a user's point of view.

In an embodiment, the at least one antenna comprises an electrically isolating cladding. The cladding may be different from the cover. The cladding may be a plastic cladding. The cladding may be a thin coating, for instance of a plastic. The cladding may be made of a polymer. The cladding may be used to electrically isolate the antenna from the two or more rigid electrodes.

Thereby, an antenna is provided which is particularly simple to provide with an appearance being similar to a single LED filament of the LED filament lamp, especially by the antenna being provided with one or more of the same color, same shape, same length and same width as the one or more LED filaments, and which is furthermore well protected from external influences, such as moist or dust.

In an embodiment, the LED filament lamp comprises two or more LED filaments, and the at least one antenna is arranged at an end, a beginning or a central position in an LED filament arrangement formed by at least two, three, four or five of the one or more LED filaments. Especially the at least one antenna is arranged at an end (e.g. at the top) or at a beginning (e.g. at the bottom) in an LED filament arrangement.

The beginning of the LED filament arrangement is intended to refer to a position between the stem of the LED filament lamp and the LED filament arrangement. Likewise, the end of the LED filament arrangement is intended to refer to a position where all LED filaments of the LED filament arrangement are arranged between the stem of the LED filament lamp and the antenna. A central position in the LED filament arrangement is intended to refer to a position midways, or approximately midways, between the end and the beginning. It is noted that positions between the beginning and the central position, as well as positions between the end and the central position also exist.

Thereby, a LED filament lamp in which the antenna to a minimized extend or not at all interferes with the light output of the LED filament lamp is obtained in a very simple manner. An antenna placed in such a position is furthermore very discreet in the off-state of the LED filament lamp. This in turn also provides for a LED filament lamp being rendered more aesthetic from a user's point of view.

In an embodiment, the LED filament lamp further comprises an envelope and an exhaust tube enclosing a gas in a volume in a gastight manner, where the one or more LED filaments and the antenna are arranged in the volume, and where the LED filament lamp further comprises a cap configured for electrically and mechanically connecting the LED filament lamp to a socket.

Thereby, and even more so if the gas sealed between the envelope and the exhaust tube is an inert gas, a particularly durable LED filament lamp is provided since the gas forms a protective barrier between the envelope and the one or more LED filaments and antenna.

In an embodiment, the LED filament lamp further comprises two electrically conductive cap wires fed through the exhaust tube in a gastight manner, and electrically connecting the cap with the controller.

In an embodiment, the controller comprises a driver.

In an embodiment, the LED filament lamp further comprises a driver located in the cap, and the electrically conductive cap wires connect the cap with the controller via the driver.

In an embodiment, the radio, or the radio and the controller, is arranged between the envelope and the exhaust tube.

Thereby, the driver or controller is also shielded from the surroundings by the envelope, and where present also by the gas present within the envelope. Thereby a more durable LED filament lamp is provided for. Also, such a positioning of the controller or driver also enables providing a LED filament lamp with a more compact and slim structure.

In an embodiment, the LED filament lamp further comprises an envelope at least partly enclosing the one or more LED filaments, e.g., a plurality of LED filaments, such as for example at least 3 or 4 LED filaments.

Thereby, the one or more LED filaments is also shielded from the surroundings by the envelope, and where present also by the gas present within the envelope. Thereby a more durable LED filament lamp is provided for.

In an embodiment, the LED filament lamp further comprises a cap configured for electrically and mechanically connecting the LED filament lamp to a socket.

In an embodiment, the one or more LED filaments comprises a plurality of N LED filaments, where N is at least 3, and where the antenna and the plurality of LED filaments are arranged according to a virtual cylinder arrangement around a longitudinal axis of the LED filament lamp.

The invention further relates to a luminaire comprising a socket and a LED filament lamp according to the invention.

It is noted that the invention relates to all possible combinations of features recited in the claims.

### BRIEF DESCRIPTION OF THE DRAWINGS

This and other aspects of the present invention will now be described in more detail, with reference to the appended drawings showing embodiment(s) of the invention.

FIG. 1 shows a schematical, cross-sectional view of a first embodiment of a LED filament lamp according to the invention.

FIG. 2 shows a cross-sectional view of a second embodiment of a LED filament lamp according to the invention.

FIG. 3 shows a cross-sectional view of a third embodiment of a LED filament lamp according to the invention.

FIG. 4 shows a cross-sectional view of a fourth embodiment of a LED filament lamp according to the invention.

FIG. 5 shows a perspective view of a fifth embodiment of a LED filament lamp according to the invention.

FIG. 6 schematically shows a luminaire comprising a LED filament lamp according to the invention.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

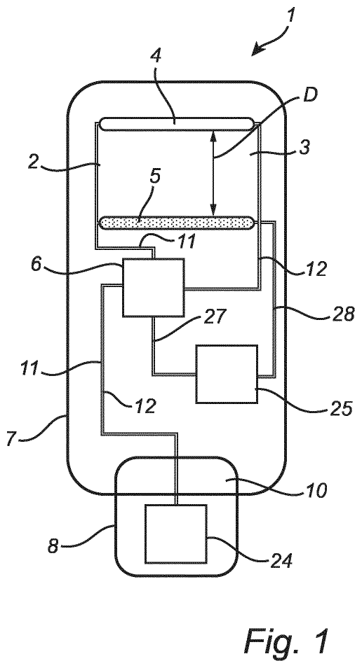

FIG. 1 shows a cross-sectional view of a first embodiment of a LED filament lamp 1 according to the invention. Generally, and irrespective of the embodiment, the LED filament lamp 1 is adapted for, in operation, emitting LED filament lamp light, and comprises at least two rigid electrically conducting wires 2 and 3, one or more LED filaments 4, an antenna 5, a radio 25 and a controller 6.

In the embodiment shown in FIG. 1, the LED filament lamp 1 comprises only one LED filament 4. Generally, and irrespective of the embodiment, the one or more LED filaments 4 are electrically connected to the at least two rigid electrically conducting wires 2 and 3 such as to ensure supply of electrical power to the one or more LED filaments 4. In the embodiment shown in FIG. 1, the LED filament 4 and the two rigid electrically conducting wires 2 and 3 are directly connected. The LED filament 4 may further be connected across the two rigid electrically conducting wires 2 and 3.

The at least two rigid electrically conductive wires 2 and 3 may be rigid electrically conductive wires. The at least two rigid electrically conductive wires 2 and 3 may have a diameter of at least 2 mm. The at least two rigid electrically conductive wires 2 and 3 may comprise or may be made of copper.

The one or more LED filaments 4 may be any suitable type of LED filaments. The one or more LED filament 4 may (each) comprise a plurality of LEDs as described by way of introduction. In the embodiment shown in FIG. 1, one LED filament 4 is provided.

LED filament lamps according to the invention and comprising other numbers of LED filaments, such as two, three four or more than four are also feasible. The one or more LED filaments 4 provide LED filament light. The LED filament light may be white light having a correlated color temperature in a range from 1500K to 6500K and/or a color rendering index of at least 80. The one or more LED filaments 4 may comprise at least two LED filaments, preferably at least three LED filaments, more preferably at least four LED filaments, most preferably at least five LED filaments. The LED filament lamp light is formed by the combination of the LED filament light provided by the LED filaments 4 present. The LED filament lamp light may be white light having a correlated color temperature in a range from 1500K to 6500K and/or a color rendering index of at least 80.

Generally, and irrespective of the embodiment, the antenna 5 is connected to both rigid electrically conducting wires 2 and 3, but electrically isolated from one of the two rigid electrically conducting wires 2 and 3 by a mechanical yet electrically isolating connector. The antenna 5 may be electrically connected to one of the two rigid electrically conducting wires 2 and 3. The antenna 5 is furthermore electrically coupled to the radio 25. The antenna 5 is configured to send and receive electromagnetic signals such as to provide that the LED filament lamp 1 is a connected LED filament lamp.

The antenna 5 is further spaced apart from the or each LED filament 4 by a distance D. More generally, the antenna 5 is spaced apart from each of the one or more LED filaments 4 by a distance D. The distance D is larger than 0 cm, preferably at least 0.5 cm, more preferably at least 1 cm, most preferably at least 2 cm. Such a distance D is required to reduce or prevent interference and to improve the sending and/or receiving performance of the antenna 5. The distance D is measured as the shortest distance between the (light emitting part of the) LED filament 4 and the (sending and/or receiving part of the) antenna 5.

The antenna 5 may be provided with at least one of the same color, shape, length, width, and orientation as the one or more LED filaments 41-43. The antenna 5 further comprises a cladding 51. The cladding 51 may for instance be a plastic cladding or a polymer cladding. The cladding 51 is an optional feature. In the embodiment shown in FIG. 1, the antenna 5 is arranged at the beginning of an LED filament arrangement formed by the one or more LED filaments 41-43. In this connection “beginning” is to be understood as defined in the introductory description or as a position closest to a cap 8 of the LED filament lamp, or a position being closer to the cap 8 than the position of the one or more LED filaments 41-43.

The antenna 5 may alternatively also be arranged at the end of or at a central position in an LED filament arrangement formed by the one or more LED filaments 41-43. In this connection “end” is to be understood as defined in the introductory description or as a position farthest from a cap 8 of the LED filament lamp, or a position being farther from the cap 8 than the position of the one or more LED filaments 41-43. Similarly, “central position” is to be understood as defined in the introductory description or as a position being in or close to the center of the LED filament arrangement formed by the one or more LED filaments 41-43.

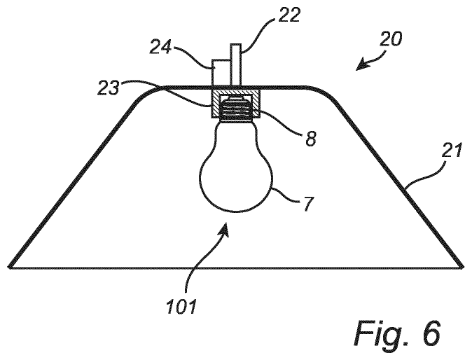

In the embodiment shown in FIG. 1, one antenna 5 is provided. It is also feasible to provide more than one, such as two or three, antennas 5. The controller 6 is adapted for controlling the antenna 5, and more particularly for controlling the emission and/or reception of electromagnetic signals from and/or to the antenna 5. The controller 6 and/or the antenna 5 may act in reaction to a command sent from a driver 24 to be described further below in relation to FIG. 6.

In the embodiment shown in FIG. 1, the antenna 5 and the one or more LED filaments are arranged in parallel. Furthermore, the two rigid electrically conducting wires 2 and 3 extend mutually in parallel.

Irrespective of the embodiment, the LED filament lamp 1 further comprises a radio 25. The radio 25 may be any one of a radio communication unit, a radio unit, a radio frequency unit, and a RF unit. The radio 25 may further comprise one or more of a modulator, a digital/audio converter (DAC) and an amplifier. The controller 6 is functionally, and preferably electrically, connected to the radio 25, for instance by a connecting wire 27. The antenna 5 is electrically connected to the radio, for instance by a connecting wire 28.

Irrespective of the embodiment, the LED filament lamp 1 further comprises an envelope 7 at least partially enveloping at least the one or more LED filaments 41-43 of the LED filament lamp 1. The envelope 7 may optionally also at least partially envelope one or more of the two rigid electrically conducting wires 2 and 3, the antenna 5 and the controller 6 of the LED filament lamp 1. The envelope 7 of the LED filament lamp 1 may further and optionally be provided with a coating, such as a reflective coating, covering at least a part of the envelope 7.

Irrespective of the embodiment, the LED filament lamp 1 further comprises a cap 8. The cap 8 is configured for electrically and mechanically connecting the LED filament lamp 1 to a socket 23 (cf. FIG. 6). The cap 8 may comprise a threading 13. The cap 8 may comprise an electrical terminal 9 for connection to an external source of electrical energy.

The LED filament lamp 1 further comprises an exhaust tube 10. The exhaust tube 10 is arranged, preferably centrally, in a stem 14 of the LED filament lamp 1. The exhaust tube 10 is configured for sealing a gas between the envelope 7 and the exhaust tube 10. The controller 6 may be arranged between the envelope 7 and the exhaust tube 10. The envelope 7 encloses the LED filaments 41-43 at least partly.

The LED filament lamp 1 further comprises two electrically conductive cap wires 11 and 12. The two electrically conductive cap wires 11 and 12 are separate from the at least two rigid electrically conducting wires 2 and 3. The two electrically conductive cap wires 11 and 12 are connected to the antenna 5 at one end 16. In the embodiment shown in FIG. 1, the connection between the antenna 5 and the electrically conductive wire 11 is achieved by means of a wire segment 15. The two electrically conductive cap wires 11 and 12 penetrate the exhaust tube 14 to be electrically connected at another end (not visible on the Figs.) opposite to the end 16 to a driver 24 (cf. FIG. 6) or to the controller 6 or to a power source.

The LED filament lamp 1 is shown having a tube-shaped envelope 7. However, other shapes of envelopes, for instance configured to resemble other types of classic light bulbs, are also feasible. Examples are globe-shaped, spherical, drop-shaped, candle bulb-shaped and spotlight shaped.

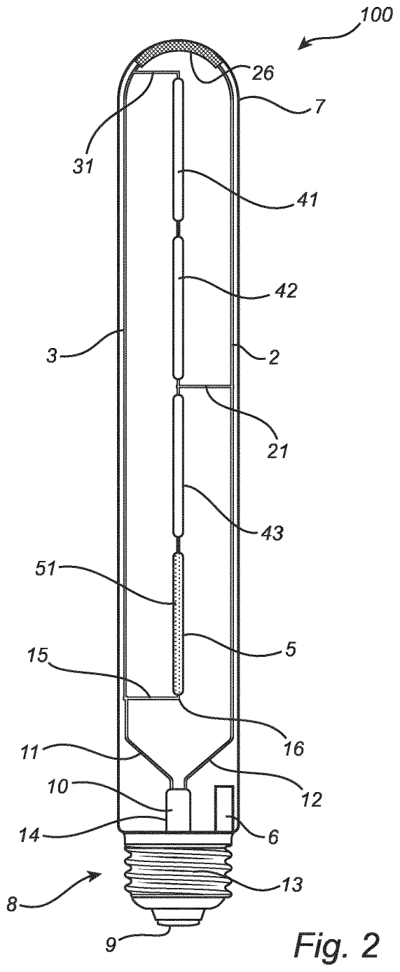

FIG. 2 shows a cross-sectional view of a second embodiment of a LED filament lamp 100 according to the invention. The LED filament lamp 100 differs from that described above in relation to FIG. 1 in virtue of the following features.

The radio 25 and the connecting wires 27 and 28 are not shown for the sake of simplicity. The LED lamp comprises a plurality of, particularly three, LED filaments 41, 42 and 43.

Generally, and irrespective of the embodiment, the one or more LED filaments 41-43 are electrically connected to the at least two rigid electrically conducting wires 2 and 3 such as to ensure supply of electrical power to the one or more LED filaments 41-43. In the embodiment shown in FIG. 2, the electrical connection between the one or more LED filaments 41-43 and the at least two rigid electrically conducting wires 2 and 3 is achieved by means of a respective electrically conducting wire segment 21 and 31. Alternatively, the one or more LED filaments 41-43 and the at least two rigid electrically conducting wires 2 and 3 may be directly connected. The one or more LED filaments 41-43 may further be connected across the two rigid electrically conducting wires 2 and 3.

The rigid electrically conducting wires 2 and 3 are not directly electrically connected to each other. In the embodiment shown in FIG. 2, the rigid electrically conducting wires 2 and 3 are electrically separated from one another, but mechanically connected. This is obtained by providing an optional connection part 26. The connection part 26 may for instance be a plastic tubing. Alternatively, the rigid electrically conducting wires 2 and 3 may be separated electrically and mechanically from one another by providing a gap between the rigid electrically conducting wires 2 and 3 at the place of the connection part 26.

In the embodiment shown in FIG. 2, the plurality of LED filaments 41-43 and the antenna 5 further extend mutually parallel in line, the antenna 5 at one side being electrically isolated by the electrically isolating connector from the rigid electrical conducting wire 2 and the plurality of LED filaments 41-43.

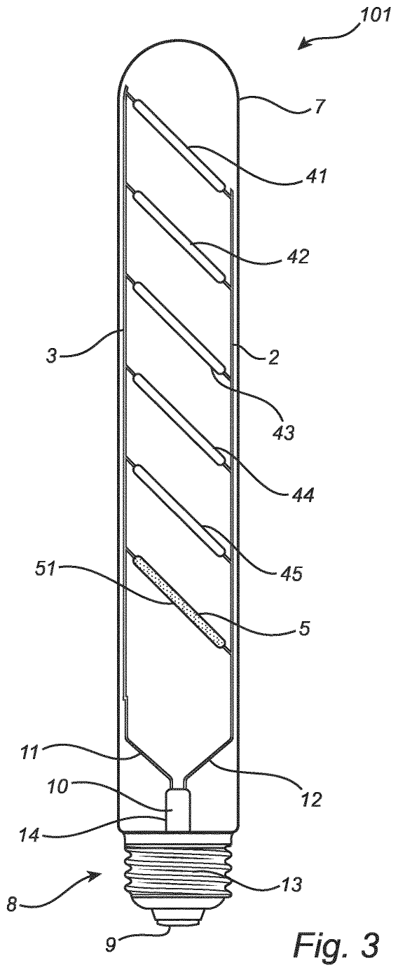

FIG. 3 shows a cross-sectional view of a third embodiment of a LED filament lamp 101 according to the invention. The LED filament lamp 101 differs from that described above in relation to FIG. 2 in virtue of the following features.

A plurality of LED filaments 41-45 comprising five LED filaments 41-45 are provided. The plurality of LED filaments 41-45 are arranged in a column configuration. Each LED of the plurality of LED filaments 41-45 is mechanically and electrically connected across the two rigid electrically conducting wires 2 and 3, the antenna 5 is mechanically and electrically connected to the rigid electrically conducting wire 2, but only mechanically connected to the electrically conducting wire 3 by the mechanical yet electrically isolating connector. The antenna 5 and the plurality of LED filaments 41-45 are arranged in parallel and extend mutually parallel substantially next to each other.

The rigid electrically conducting wires 2 and 3 are not directly electrically connected to each other. In the embodiment shown in FIG. 2, the rigid electrically conducting wires 2 and 3 are separated electrically and mechanically from one another by providing a gap between the rigid electrically conducting wires 2 and 3 above the LED filament 41 in FIG. 3, i.e., on a side of the LED filament 41 opposite to the LED filament 42. Alternatively, the rigid electrically conducting wires 2 and 3 may be electrically separated from one another, but mechanically connected, for instance by providing an optional connection part 26.

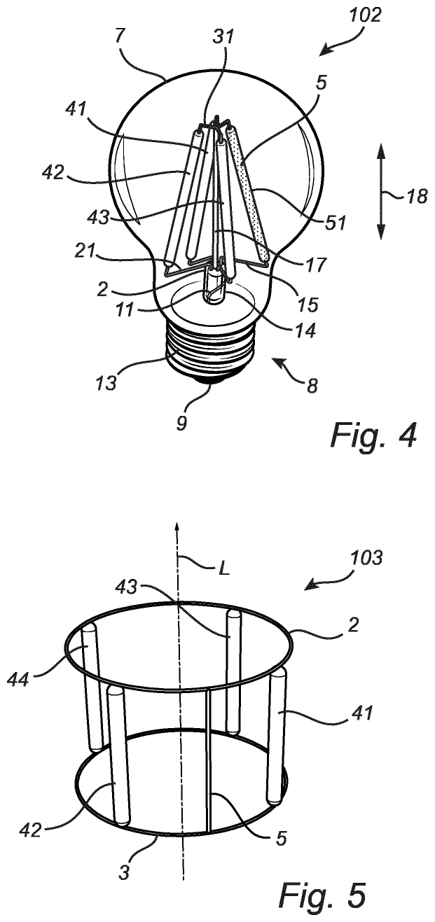

FIG. 4 shows a cross-sectional view of a fourth embodiment of a LED filament lamp 102 according to the invention. The LED filament lamp 102 differs from those described above in relation to FIGS. 2 and 3 only in virtue of the following features.

The LED filament lamp 102 comprises an envelope 7 being shaped to resemble as a classic incandescent light bulb. The plurality of LED filaments 41-43 are arranged extending in parallel with or in an acute angle with the vertical (cf. arrow 18). The plurality of LED filaments 41-43 are further connected in parallel to the two rigid electrically conducting wires 2 and 3. At least the rigid electrically conducting wire 3 extends within a support stem 17. The plurality of LED filaments 41-43 are connected to the rigid electrically conducting wire 3 by means of electrically conducting wire segments 31 or support wires. Via the mechanical yet electrically isolating connectors, the antenna 5 is mechanically connected but electrically isolated from the rigid electrically conducting wire 2 and from the electrically conducting wire segments 31 of the rigid electrically conducting wire 3. Similarly, the plurality of LED filaments 41-43 are connected to the rigid electrically conducting wire 2 by means of electrically conducting wire segments 21 or support wires.

FIG. 5 shows a perspective view of a fifth embodiment of a LED filament lamp 103 according to the invention and where only the LED filaments 41-44, the antenna 5 and the rigid electrically conducting wires 2 and 3 are shown for simplicity. The LED filament lamp 103 differs from those described above in relation to FIGS. 1 to 4 only in virtue of the following features.

The one or more LED filaments 41-44 in this embodiment generally comprises a plurality of N LED filaments, wherein N is at least 3. In the embodiment shown, N is by way of a non-limiting example chosen to be four. The antenna 5 and the plurality of LED filaments 41-44 are arranged according to a virtual cylinder arrangement around a longitudinal axis L of the LED filament lamp 103. The antenna 5 and the plurality of LED filaments 41-44 are shown arranged extending next to each other in parallel with the longitudinal axis L of the LED filament lamp 103, albeit this need not necessarily be the case. The antenna 5 being mechanically connected but electrically isolated from both the two rigid electrically conducting wires 2, 3 by the mechanical yet electrically isolating connectors.

Turning finally to FIG. 6, an exemplary luminaire in the form of a pendant 20 is shown. The pendant 20 comprises a LED filament lamp 1, 100, 101, 102, 103 according to any embodiment of the invention. In the embodiment shown, the LED filament lamp 102 is of the type shown in FIG. 4 and comprises substantially straight filaments. The filaments of such a LED filament lamp 1 may in other embodiments be filaments with another shape, such as, but not limited to, spiral-shaped, helix-shaped, meandering, twisted, flat and combinations thereof. In such a case the at least one antenna 5 may comprise a shape corresponding to the shape of the filaments.

The pendant 20 further comprises a socket 23 for connecting the LED filament lamp 101 to the pendant 20. The socket 23 is adapted to cooperate with the cap 8 of the LED filament lamp 1. The socket 23 may comprise a threading adapted to cooperate with the threading 13 of the LED filament lamp 1. The socket 23 may comprise a terminal adapted to cooperate with the terminal 9 of the LED filament lamp 1.

The pendant 20 may further comprise a driver 24 configured for controlling the LED filament lamp 1. The driver 24 may or may not be the same unit as the controller 6 described above. In other words, the driver 24 and the controller 6 may be integrated into one and the same driver or controller, or they may be mutually separate units. The driver 24 is configured to power the plurality of LED filaments 41-45 via the electrically conducting wires 2 and 3 of the LED filament lamp 1. The driver 24 may further be configured for controlling at least one of the CCT of the LED filament lamp light and the CRI of the LED filament lamp light. The driver 24 may also be configured for controlling other parameters related to the LED filament lamp light sources and the LED filament lamp light.

As shown in FIG. 6, the driver 24 is arranged on a reflector or screen 21 of the pendant 20. The driver may also be arranged within or incorporated into the reflector or screen 21. The pendant 20 further comprises an electrical wiring 22 for connection to a source of electricity, such as a mains.

It is noted that the pendant 20 shown in FIG. 6 is only one example of a luminaire according to the invention. Any suitable type of luminaire may be envisaged, such as but not limited to, a standing luminaire, a wall hung luminaire, a chandelier, a reading luminaire, an outdoor luminaire and a table luminaire.

The person skilled in the art realizes that the present invention by no means is limited to the preferred embodiments described above. On the contrary, many modifications and variations are possible within the scope of the appended claims.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A LED filament lamp adapted for, in operation, emitting LED filament lamp light, the LED filament lamp comprising:
at least two rigid electrically conducting wires,
one or more LED filaments,
a controller
a radio, and
an antenna;
wherein the one or more LED filaments are mechanically and electrically connected to the at least two rigid electrically conducting wires and the at least two rigid electrically conducting wires are electrically connected to the controller;
wherein the antenna is mechanically connected to the at least two rigid electrically conducting wires, and the antenna is electrically isolated from the at least two rigid electrically conducting wires, or the antenna is electrically connected to only one of the at least two rigid electrically conducting wires;
wherein the controller is functionally coupled to the radio;
wherein the antenna is electrically coupled to the radio; and
wherein the antenna is spaced apart from each of the one or more LED filaments and
wherein the antenna is provided with a cover covering the antenna at least partly, and wherein the cover comprises one or more of:
the same color,
the same length,
the same width and/or,
the same thickness,
as at least one of the one or more LED filaments.

2. A LED filament lamp according to claim 1, wherein at the location where the one or more LED filaments and the antenna are mechanically connected to the two rigid electrically conducting wires the at least two rigid electrically conducting wires extend alongside each other, preferably extend mutually in parallel.

3. A LED filament lamp according to claim 1, wherein the one or more LED filaments extend mutually in parallel.

4. A LED filament lamp according to claim 1, wherein the one or more LED filaments are arranged in a column configuration.

5. A LED filament lamp according to claim 1, wherein the antenna and the one or more LED filaments are arranged in parallel.

6. A LED filament lamp according to claim 4, wherein the antenna and the one or more LED filaments are arranged in the column configuration.

7. A LED filament lamp according to claim 1, wherein the cover comprises the same shape and/or the same orientation with respect to the longitudinal axis of the LED filament lamp, as at least one of the one or more LED filaments.

8. A LED filament lamp according to claim 1, wherein the at least one antenna comprises an electrically isolating cladding.

9. A LED filament lamp according to claim 1, wherein the antenna is arranged at an end, a beginning or a central position in an LED filament arrangement formed by at least two of the one or more LED filaments.

10. A LED filament lamp according to claim 1, wherein the LED filament lamp further comprises an envelope and an exhaust tube enclosing a gas in a volume in a gastight manner;
wherein the one or more LED filaments and the antenna are arranged in the volume;
wherein the LED filament lamp further comprises a cap configured for electrically and mechanically connecting the LED filament lamp to a socket.

11. A LED filament lamp according to claim 10, and further comprising two electrically conductive cap wires feed through the exhaust tube in a gastight manner and electrically connecting the cap with the controller.

12. A LED filament lamp according to claim 11, comprising a driver located in the cap, and wherein the electrically conductive cap wires connecting the cap via the driver with the controller.

13. A LED filament lamp according to claim 10, wherein (i) the radio or (ii) the radio and the controller are arranged between the envelope and the exhaust tube.

14. A LED filament lamp according to claim 1, wherein the one or more LED filaments comprises a plurality of N LED filaments, wherein N is at least 3, and wherein the antenna and the plurality of LED filaments are arranged according to a virtual cylinder arrangement around a longitudinal axis of the LED filament lamp.

15. A luminaire comprising socket and a LED filament lamp according to claim 1.
